(19) United States
(12) Patent Application Publication
(10) Pub. No.: US 2017/0016130 A1
(43) Pub. Date: Jan. 19, 2017

(54) ELECTRODEPOSITION METHODS AND COATED COMPONENTS

(71) Applicant: Xtalic Corporation, Marlborough, MA (US)

(72) Inventors: Anne L. Testoni, Bolton, MA (US); Darci Silva, Jefferson, MA (US); John Cahalen, Arlington, MA (US); Peteris Griffiths, Waltham, MA (US); Michael Peritz, Cambridge, MA (US); Jonathan Brunell, Holden, MA (US); Marina Kaufman, Brookline, MA (US); Susan C. Woods, Sutton, MA (US)

(73) Assignee: Xtalic Corporation, Marlborough, MA (US)

(21) Appl. No.: 15/210,271

(22) Filed: Jul. 14, 2016

Related U.S. Application Data
(60) Provisional application No. 62/193,064, filed on Jul. 15, 2015.

(51) Int. Cl. C25D 3/56; H01R 4/58; C25D 11/26; C25D 5/48; C25D 7/00

(52) U.S. Cl. CPC C25D 3/562; C25D 5/48; C25D 7/00; C25D 11/26; H01R 4/58

(57) ABSTRACT

Electrodeposition methods and coated articles (e.g., electrical connectors) are described herein.

### RELATED APPLICATIONS

This application claims priority to U.S. Patent Application Ser. No. 62/193,064, filed Jul. 15, 2015, which is incorporated herein by reference in its entirety.

### FIELD OF INVENTION

The present invention generally relates to electrodeposition methods and coated components.

### BACKGROUND OF INVENTION

Many types of coatings may be applied on a base material. Electrodeposition is a common technique for depositing such coatings. Electrodeposition generally involves applying a voltage to a base material placed in an electrodeposition bath to reduce metal ionic species within the bath which deposit on the base material in the form of a metal, or metal alloy, coating. The voltage may be applied between an anode and a cathode using a power supply. At least one of the anode or cathode may serve as the base material to be coated. In some electrodeposition processes, the voltage may be applied as a complex waveform such as in pulse plating, alternating current plating, or reverse-pulse plating.

A variety of metal and metal alloy coatings may be deposited using electrodeposition. Coated articles may be used in a wide variety of applications. For example, electrical connectors may include a conductive base material and a coating. The coating may have several layers which impart different characteristics. In some applications, it is important for electrical connectors to meet certain mechanical, electrical and appearance characteristics. Accordingly, there is a need for processes capable of producing coated connectors having the desired mechanical, electrical and appearance characteristics.

### SUMMARY OF INVENTION

Electrodeposition methods and coated components are provided.

In one aspect, a method is provided. The method comprises loading a barrel with a plurality of components; rotating the barrel in an electroplating bath; and electroplating a nickel tungsten alloy layer on surfaces of the components. The electroplating rate is between 0.001 microns/minute and 10.0 microns/minute and the nickel tungsten alloy layer forms at least a portion of a coating on surfaces of the components.

In another aspect, an electrical connector is provided. The electrical connector comprises a conductive base and a nickel tungsten alloy layer formed on the base material. The electrical connector is free of a layer comprising tin or a precious metal.

In another aspect, an electrical connector is provided. The electrical connector comprises a conductive base and a nickel tungsten alloy layer formed on the conductive base. The electrical connector is configured to provide electrical grounding.

In another aspect, an electrical connector is provided. The electrical connector comprises a conductive base and a nickel tungsten alloy layer formed on the conductive base. The electrical connector is configured to provide mechanical attachment. Other aspects, embodiments and features of the invention will become apparent from the following detailed description. All patent applications and patents incorporated herein by reference are incorporated by reference in their entirety. In case of conflict, the present specification, including definitions, will control.

### BRIEF DESCRIPTION OF DRAWINGS

FIG. 1 is a graph showing yield versus the ratio of bath volume to surface area of components as described further below in Example 1.

FIG. 2 is a graph showing yield versus bath pH as described further below in Example 2.

FIG. 3 is a graph showing yield versus time between plating and passivation as described further below in Example 3.

### DETAILED DESCRIPTION

Electrodeposition methods and coated components (e.g., electrical connectors) are described herein. The methods generally utilize a barrel plating process for depositing a nickel tungsten alloy layer on a component. Barrel plating can be used to simultaneously coat a large number of components. In some cases, the components may be a conductive base material that is coated with a nickel tungsten alloy layer and, in some cases, other metal layers. The coated components may be used, for example, as electrical connectors. As described further below, the inventors have appreciated that certain barrel processing parameters are important in forming a nickel tungsten layer (alone or in combination with other layers of the coating) which enables formation of electrical connectors having desirable characteristics including excellent mechanical and electrical properties, as well as a high quality appearance.

In general, the barrel plating processes described herein involve loading many small components to be coated into a barrel. For example, typical barrel loading volumes (volume of barrel occupied by components) are in the range of 20%-75% and, in some cases, 40%-60%.

The barrel plating apparatus is configured such that the components are in contact with an electroplating bath. As described further below, the bath includes appropriate chemical species including metal ionic species (e.g., nickel ionic species and tungsten ionic species) which are deposited in the form of an alloy (e.g., nickel and tungsten) during the plating process. In some cases, the barrel is placed in the bath (which may be contained in a tank) and perforations in the barrel walls enable the bath to contact the components.

It has been observed in certain processes that the ratio of the bath volume (i.e., volume of liquid bath) to the surface area of components can be an important parameter that effects the appearance and quality of the resulting nickel tungsten alloy layer. In some processes, it is desirable for the ratio to be greater than or equal to 30 and, in some cases, greater than or equal to 35.

It has also been observed in certain processes that the ratio of the bath volume (i.e., volume of liquid bath) to barrel load volume (i.e., volume of components in the barrel) can be an important parameter that also effects the appearance and quality of the resulting nickel tungsten alloy layer. For example, it may be advantageous for the ratio to be greater than or equal to 35 or greater than or equal to 40.

Within the barrel, the components are in electrical contact with one or more other components. An electrical lead extends within the volume of the barrel and contacts at least some the components during use. The lead is connected to a power supply so that it can function as a “barrel” electrode used in the electrodeposition process to provide electrical current to the components. The electrical lead can be a conductive wire such as a metal wire, or a series of metal wires in electrical contact with one another. The electrical lead can also be a conductive rod or other geometry of conductive material, or an assembly of many such geometries. In some cases, functional geometries are part of the electrical lead as in the case of mechanical clips, clamps, screws, hooks, or brushes which facilitate electrical contact with components. The electrical lead need not be stationary, but can move due to the agitation of the process. For example, the electrical lead can be coupled to the barrel.

The barrel coating apparatus can include a “bath” electrode which is in contact with the electroplating bath. For example, the bath electrode may be immersed in the bath. During plating, a voltage is applied between the barrel and bath electrodes using the power supply. The electrical current passes from the power supply through the barrel electrode, and into the components with which it is in contact and to the other components in the barrel via the physical contacts between the components. As the barrel rotates, all of the components are in contact with one another and, thus, function as a single electrode. As a result of the potential on the components, metal ionic species (e.g., nickel ionic species, tungsten ionic species) in the bath are reduced on the component surfaces and deposit in the form of a layer on the components.

In some embodiments, substantially constant voltage is applied between the electrodes. Such embodiments are known as direct current (DC) plating. In other embodiments, the voltage is modulated (i.e., varied) during the deposition process. In some processes, the voltage (and resulting current) may be pulsed. For example, techniques known as pulsed plating, reverse pulse plating, or combinations thereof may be utilized. Suitable pulse techniques for depositing nickel tungsten alloy layers have been described, for example, in U.S. Pat. No. 7,425,255 which is incorporated herein by reference in its entirety.

The barrel plating apparatus can include a variety of devices and/or mechanisms which help control the processing parameters and a variety of sensors, for example, to measure properties of the bath. The sensors may measure temperature, bath composition, pH, viscosity and other properties.

The barrel plating apparatus can include a motor that is configured to rotate the barrel. It has been observed that barrel rotation can be an important parameter in certain processes for controlling coating (e.g., nickel tungsten alloy) adhesion and plating rate. For example, barrel rotation linear velocities of 1-20 cm/sec, and in some cases, between 3-10 cm/sec may lead to excellent adhesion at desirable plating rates in certain processes. Suitable barrel rotation rates may be between 4-30 rpm and, in some cases, between 10-15 rpm. Suitable barrel rotation rates may depend on the size of the barrel diameter in certain processes.

As described above, the electrodeposition processes use suitable electrodeposition bath chemistries for depositing nickel tungsten alloy layers. For example, the electrodeposition bath comprises nickel species (e.g., nickel sulfate) and tungsten species (e.g., sodium tungstate). Typically, the electrodeposition baths comprise an aqueous fluid carrier (e.g., water). The electrodeposition baths may include other additives, such as wetting agents, brightening or leveling agents, and the like. Those of ordinary skill in the art would be able to select appropriate additives for use in a particular application. In some cases, the electrodeposition bath includes citrate ions as additives. In some cases, the citrate ion content may be from about 35-150 g/L, 40-80 g/L, or, in some cases, 60-66 g/L. Suitable bath components for plating nickel tungsten alloy layers have been described, for example, in commonly-owned U.S. Pat. No. 8,071,387 which is incorporated herein by reference in its entirety.

In some embodiments, the barrel plating apparatus includes a stirring mechanism to stir the electrodeposition bath. Stirring leads to agitation of the components within the bath which can be important in ensuring the uniformity of the coating process. The stirring mechanism may be, for example, a mechanical stirrer and/or a pump.

The bath tank may include feeds for adding suitable chemicals to the bath during processing. For example, pH controlling agents may be added to the bath to adjust pH. In some embodiments, when depositing nickel tungsten alloy, it is preferable for the pH to be greater than 7.8 (e.g., between 7.8 and 9.0, between 7.8 and 8.6); in some cases, greater than 8.1 (e.g., between 8.1 and 8.5); and, in some cases, greater than 8.3 (e.g., between 8.3 and 9.0, between 8.3 and 8.6). Suitable pH controlling agents include ammonium hydroxide, amongst others.

In some embodiments, the barrel plating apparatus includes some means for controlling the temperature of the bath. Temperature control means can include heaters that heat barrel walls of the bath and/or the bath directly. A variety of suitable temperature control means may be used.

The processing parameters may be controlled to provide a suitable plating rate for the nickel tungsten alloy layer. It has been observed that plating rate can play an important role in depositing quality coatings including having effects on coating adhesion, amongst other characteristics. In some embodiments, the plating rate is greater than 0.001 microns/minute; in some embodiments, greater than 0.005 microns/minute; in some embodiments, greater than 0.01 microns/minute; and in some embodiments, greater than 0.05 microns minute. In some embodiments, the plating rate is less than 10.0 microns/minute; in some embodiments, less than 5.0 microns/minute; in some embodiments, less than 2.0 microns/minute; and, in some embodiments, less than 1.0 microns/minute. It should be understood that any suitable ranges defined by the above-noted upper and lower limits may be possible (e.g., between 0.001 microns/minute and 10.0 microns/minute; between 0.01 microns/minute and 5.0 microns/minute; 0.01 microns/minute and 0.5 microns/minute; 0.01 microns/minute and 1.0 microns/minute; and, 0.05 microns/minute and 1.0 microns/minute, and the like). For example, it has been shown that, in some embodiments, a plating rate of between 0.005 and 0.20 microns/minute and, in some cases, between 0.05 and 0.2 microns/minute, can lead to particularly high quality nickel tungsten alloy layers.

The barrel plating processes may be conducted in a batch mode, or in a continuous mode. In a continuous operation some mechanism of introducing and removing components at a regular rate is introduced.

Suitable barrel coating apparatus have been descried in commonly-owned U.S. Pat. No. 8,500,986 which is incorporated herein by reference in its entirety.

As noted above, the nickel tungsten alloy layer can contribute to imparting desirable characteristics to the resulting components. In some cases, the nickel tungsten alloy layer has a nanocrystalline grain structure. As used herein, a “nanocrystalline” grain structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. In some embodiments, the nickel tungsten alloy layer has an “amorphous” grain structure. As known in the art, an amorphous structure is a non-crystalline structure characterized by having no long range symmetry in the atomic positions. Examples of amorphous structures include glass, or glass-like structures.

In some embodiments, the concentration of tungsten in the nickel tungsten alloy may be between 25-50 weight percent; and, in some cases, between 20-35 weight percent. It should be understood that other concentrations may be used as well.

In general, the nickel tungsten layer may have any thickness suitable for a particular application. For example, the thickness may be between 0.05 microns and 500 microns; in some cases, between 0.1 microns and 25 microns; and in some cases, between 0.1 microns and 7.0 microns.

As described above, the nickel tungsten layer is deposited on a base material. When a layer is referred to as being “on,” “over,” or “overlying” another structure (e.g., base material, another layer), it can be directly on the structure, or an intervening structure (e.g., another layer) also may be present. A layer that is “directly on” or “in direct contact with” another structure means that no intervening structure (e.g., another layer) is present. It should also be understood that when a structure is referred to as being “on” or “over” another structure, it may cover the entire structure, or a portion of the structure.

The base material generally comprises an electrically conductive material, such as a metal, metal alloy, intermetallic material, or the like. Suitable base materials include steel (e.g., stainless steel), copper, aluminum, brass, bronze, and nickel, amongst others. In some embodiments, stainless steel base materials are preferred.

In some embodiments, the base material is pre-treated prior to electrodepositing the nickel tungsten alloy (and other layers, if present). For example, the pre-treatment steps may involve cleaning the components. Pre-treatment may also involve activating surfaces of the base material which can facilitate deposition of subsequent layers. Examples of pre-treatment steps would be ultrasonic cleaning, electrochemical cleaning, electropolishing, and acid activation (e.g., with diluted HCl, diluted sulfuric acid).

As noted above, the methods described herein can involve depositing layers, in addition to the nickel tungsten alloy layer, on the base material. In some embodiments, one or more layers (e.g., metal and/or alloy layers) are deposited on the base material prior to the above-described deposition of the nickel tungsten alloy layer. For instance, the layer(s) deposited prior to the nickel tungsten alloy layer may include a strike layer. The strike layer can be a layer that comprises nickel, e.g., nickel metal. The strike layer may have a thickness of 0.01 microns to 1.0 microns. The strike layer may be deposited in an electrodeposition process. In some cases, the strike layer may be deposited in a barrel plating process. For instance, the components may be loaded in a barrel which is immersed in a first bath to deposit the strike layer and then a second bath to deposit the nickel tungsten, as described above. The process may include a cleaning step (e.g., immersion of the barrel in one or more cleaning tanks) between the two electrodeposition steps.

In some embodiments, one or more layers (e.g., metal and/or metal alloy layers) are deposited on the nickel tungsten alloy layer. The one or more layers may be deposited using an electrodeposition process such as a barrel plating process. For instance, after the nickel tungsten alloy barrel plating process, the components may be loaded in a barrel which is immersed in a different bath to electrodeposit the other layer(s). The process may include a cleaning step (e.g., immersion of the barrel in one or more cleaning tanks) between the two electrodeposition steps. The barrel plating steps may be repeated (e.g., separated by cleaning steps) to deposit any number of layers, as desired.

In some embodiments, the layer(s) deposited on the nickel tungsten alloy layer may comprise nickel. For example, a layer comprising a second nickel tungsten alloy can be deposited on the above-described nickel tungsten alloy layer. In such embodiments, the second nickel tungsten alloy layer may have a tungsten concentration that is lower than the above-described nickel tungsten alloy layer. For example, wherein the second nickel tungsten alloy layer may have a tungsten concentration between 10 weight percent and 25 weight percent and the above-descried nickel tungsten ally layer has a tungsten concentration between 25 weight percent and 50 weight percent. Suitable thicknesses of the second nickel tungsten alloy layer include 0.1 microns to 3.0 micron, though it should be understood that thicknesses outside of this range are also envisioned.

In some cases, a nickel (e.g., metal, non-alloy) layer is deposited on the above-described nickel tungsten alloy layer. The nickel layer may have a thickness of 0.1 microns to 3.0 microns, though it should be understood that thicknesses outside of this range are also envisioned.

In some cases, a precious metal layer may be deposited on the above-described nickel tungsten alloy layer. Examples of suitable precious metals include Ru, Os, Rh, Ir, Pd, Pt, Ag, and/or Au. Gold may be preferred in some embodiments that use a precious metal.

In some embodiments and for certain applications, it may be preferable to avoid use of additional layers formed on the above-described nickel tungsten alloy layer. In these embodiments, the above-described nickel tungsten alloy layer may be the uppermost (i.e., top) layer of the structure (e.g., electrical connector). It should be understood that additional materials may be applied using other techniques (e.g., non-electrodeposition techniques) when the electrical connector is ultimately used.

In some embodiments, it may be advantageous to avoid using a precious metal layer formed on the nickel tungsten alloy layer. Such structures (e.g., electrical connectors) are free of a precious metal (i.e., Ru, Os, Rh, Jr, Pd, Pt, Ag, and/or Au) layer. In general, precious metal layers are expensive and avoiding their use can save on cost. One feature of the nickel tungsten alloy layer described herein is that it may enable formation of electrical connectors having excellent performance characteristics and appearance without the use of precious metals.

In some embodiments, it may be advantageous to avoid using an additional nickel layer and/or second nickel tungsten alloy layer which can complicate processing. Such structures (e.g., electrical connectors) are free of a nickel and/or a second nickel tungsten alloy layer.

In some embodiments, it may be advantageous to avoid using a tin layer, e.g., formed on the above-described nickel tungsten alloy layer. Such structures (e.g., electrical connectors) are free of tin. It may be advantageous to avoid using tin layer(s) because tin layers may sacrifice wear performance and may lead to migration of tin species which can result in electrical shorts.

The methods described herein may include a passivating step after the electroplating step(s). For example, the methods may involve passivating the coated components after electroplating the nickel tungsten layer and any other electroplated layers on the nickel tungsten alloy layer. The passivating step can involve exposing the coated components to a passivating solution. In some cases, the passivating solution comprises a chromate compound including dichromate compounds. For example, suitable compounds include sodium dichromate, sodium chromate, potassium dichromate and potassium chromate, amongst others. In embodiments that utilize a chromate compound for passivation, the top surface of the coated components may comprise nickel, tungsten, chromium oxide(s). It should be understood that other compounds that are not chromates may also be used to passivate the coating components.

In some embodiments, it is preferred that the coated components are passivated after electroplating and prior to drying the coated components. That is, the coated components are not allowed to dry prior to passivation. Accordingly, in some cases, the passivation process proceeds after plating within a short time period. The time period may be characterized as the time duration after the plating step (e.g., after which the plating barrel is removed from the plating bath) until the passivation step (e.g., when the barrel is immersed in a passivation solution). In some cases, the time duration (e.g., over which the coated components are exposed to air) is less than 2 minutes; in some cases, less than 1 minute; and, in some cases, less than 30 seconds. In some embodiments, the passivation step immediately proceeds the plating step.

In some embodiments, passivation involves an anodic passivation step. For example, the components are placed in an alkaline solution and a suitable voltage is placed on the components. In such anodic passivation steps, the top surface of the components may comprise nickel tungsten oxide(s).

The coated components including the above-described nickel tungsten alloy layer can be used in a variety of applications including electrical applications such as electrical connectors. In some cases, the coated components may be used to form a ground electrical connector (e.g., the electrical connector is configured to provide electrical grounding). The electrical connector, for example, may be part of a cord used to connect a mobile device (e.g., a cell phone, tablet, laptop computer) to a power source (e.g., wall plug) or another electronic device. The electrical connector (e.g., in the form of a male type plug connector) including the nickel tungsten alloy layer may be mated with a corresponding connector (e.g., female type connector) to form an electrical connection that provides power, signal, or an electrical grounding for the device. In some embodiments, the electrical connector including the nickel tungsten alloy layer may be configured to provide the mechanical attachment to the corresponding connector.

It has been discovered that the above-described coated component has a number of desirable properties that enable it to be well suited for use, in particular, in the electrical connector applications described above.

The coated components can have excellent wear resistance. The wear resistance, for example, enhances wear performance in connector applications that involve mating and un-mating during use.

The coated components may have excellent corrosion resistance. That is, the coated component is also capable of resisting corrosion, and/or protecting an underlying base material from corrosion, in one or more potential corrosive environments. Examples of such corrosive environments include, but are not limited to, salt solutions, aqueous solutions, acid solutions, alkaline or basic solutions, or combinations thereof. For example, the coated components may be resistant to corrosion upon exposure to (e.g., contact with, immersion within, etc.) a corrosive environment, such as a corrosive liquid, vapor, or humid environment.

The coated components (e.g., electrical connector) also may have a desirable appearance. Appearance is an increasingly important property in certain electrical connector applications including ones used with mobile devices. Color, as measured for example using the CIELAB color space using suitable calibrated devices and techniques, and gloss are two appearance attributes in which the coated components (e.g., electrical connector) excel.

For example, in some embodiments, the surface of the coated component may have an a* CIELAB color space value of less than 1; and, in some cases, less than 0.5. In some embodiments, the surface of the coated component may have an a* CIELAB color space value of greater than 0.1; and, in some cases, greater than 0.3. It should be understood that all suitable ranges defined by the above-described ranges are possible (e.g., greater than 0.1 and less than 0.5; greater than 0.3 and less than 0.5.

The surface of the coated components may have a b* CIELAB color space value of less than 10; and, in some embodiments, less than 6.5. In some embodiments, the surface of the coated components may have a b* CIELAB color space value of greater than 2.5; in some embodiments, greater than 3.5; and, in some embodiments, greater than 4.5. It should be understood that all suitable ranges defined by the above-described ranges are possible (e.g., greater than 3.5 and less than 6.5; greater than 4.5 and less than 6.5).

The coated component may have an L* CIELAB color space value of greater than or equal to 75. In some embodiments, the coated component is able to surprisingly achieve all of the above-noted L*a*b* CIELAB values.

In some embodiments, the surface of the coated component has a 60° specular gloss of greater than or equal to 10; in some embodiments, greater than or equal to 20; in some embodiments, greater than or equal to 30; in some embodiments, greater than or equal to 50; and, in some embodiments, greater than or equal to 80. In some embodiments, the surface of the coated component has a 60° specular gloss of less than or equal to 90; in some embodiments, less than or equal to 80; in some embodiments, less than or equal to 75; in some embodiments, less than or equal to 60; in some embodiments, less than or equal to 40; and in some embodiments, less than or equal to 20. It should be understood that all suitable ranges defined by the above-described ranges are possible (e.g., greater than or equal to 30 and less than or equal to 60).

Even though use as an electrical connector is one preferred application for the coated components, it should be understood that the coated components described herein may have other uses.

The following examples are presented for illustration purposes and are not intended to be non-limiting.

### Example 1

This example illustrates the effect of the ratio of bath volume to surface area of components on the appearance and quality of the plated Ni—W alloy layer according to some embodiments.

A variety of electroplating barrels of different geometries (length-to-diameter ratio) and sizes were used for this experimentation. Several plating tanks of varying bath volume were prepared with nickel tungsten alloy plating baths having identical chemistries (including a nickel salt, a tungsten salt, a citric acid complexing agent and other wetting and brightening agents). The experimentation involved a series of plating runs in which a number of identical components were loaded into a barrel which was immersed in a plating tank. The bath volume was varied for each run. The components were hollow and approximately rectangular in shape with a surface area of about 1 cm².

Each plating run utilized the same general process conditions with a different bath volume. The bath temperature was 60° C.; bath pH between 8.4 and 8.5; plating rate of approximately 0.1 microns/minute.

A Ni—W layer was deposited on the components during each plating run. The coated components immediately proceeded to a passivation step that involved soaking them in a dichromate solution for a fixed period of time. Following passivation, the components were dried and recovered.

The components were then evaluated by visual inspection. The components were assessed as either passing or failing. The Ni—W alloy layer on “passing” components was characterized as having a uniform appearance. On “failing” components, the Ni—W layer showed some irregularities in the form of roughness, haziness, patchiness or other irregular features.

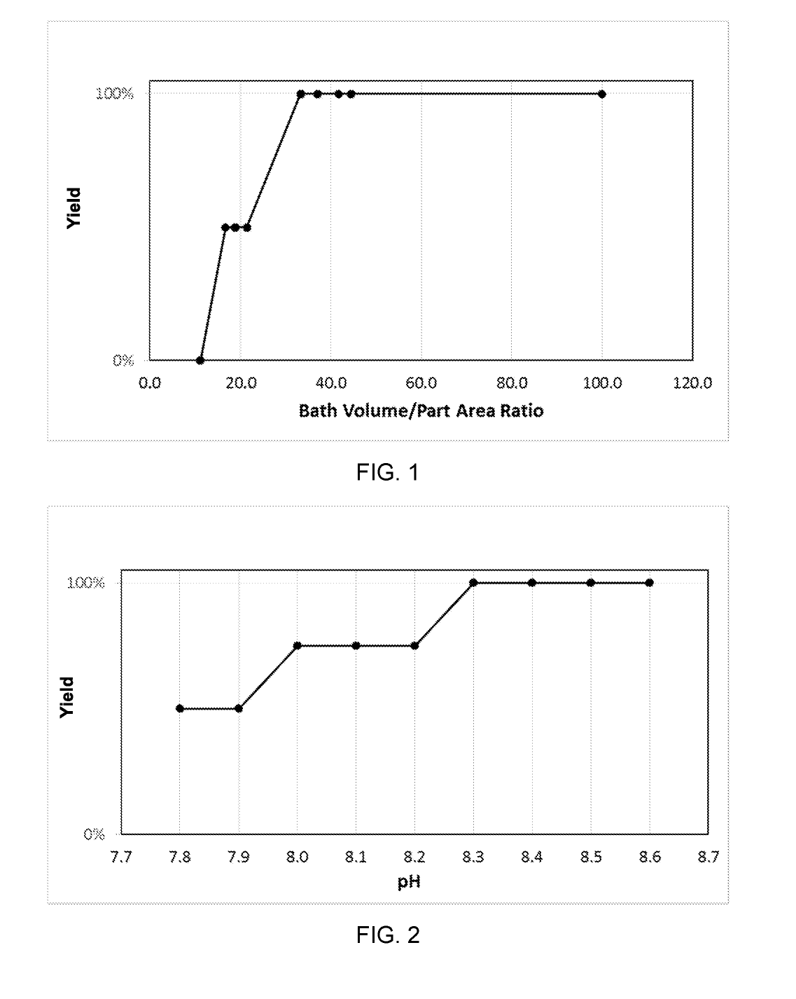

FIG. 1 is a graph showing the yield (i.e., % of the components deemed to “pass” the evaluation) versus the ratio of bath volume to surface area of the components. The graph shows that the yield depends on the bath volume to surface area of the components and, further, that a ratio of greater than about 30 resulted in a 100% yield.

### Example 2

This example illustrates the effect of bath pH on the appearance and quality of the plated Ni—W alloy layer according to some embodiments.

The experimentation involved a series of plating runs in which a number of identical components were loaded into a barrel which was immersed in a plating tank which included a plating bath. For each run, the plating bath had identical chemistries (including a nickel salt, a tungsten salt, a citric acid complexing agent and other wetting and brightening agents) except that each bath pH was pre-selected to a value between 7.8 and 8.6 by adjusting the amount of ammonium hydroxide in the bath. The pH was monitored at regular intervals (about every 10 minutes) during each plating run and was adjusted to maintain the selected value. Other process conditions were identical for each run including a bath temperature of 60° C. and a plating rate of approximately 0.1 microns/minute.

A Ni—W layer was deposited on the components during each plating run. The coated components immediately proceeded to a passivation step that involved soaking them in a dichromate solution for a fixed period of time. Following passivation, the components were dried and recovered.

The components were then evaluated by visual inspection. The components were assessed as either passing or failing. The Ni—W alloy layer on “passing” components was characterized as having a uniform appearance. On “failing components”, the Ni—W layer showed some irregularities in the form of roughness, haziness, patchiness or other irregular features.

FIG. 2 is a graph showing the yield (i.e., % of the components deemed to “pass” the evaluation) versus the bath pH. The graph shows that the yield depended on the bath pH.

### Example 3

This example illustrates the effect of time between plating and passivation on the appearance and quality of the plated Ni—W alloy layer according to some embodiments.

The experimentation involved a series of plating runs in which a number of identical components were loaded into a barrel which was immersed in a plating tank which included a plating bath. For each run, the plating bath had identical chemistries (including a nickel salt, a tungsten salt, a citric acid complexing agent and other wetting and brightening agents). Plating process conditions were identical for each run including a bath temperature of 60° C., a bath pH between 8.4 and 8.5, and a plating rate of approximately 0.1 microns/minute.

A Ni—W layer was deposited on the components during each plating run. After plating, the coated components proceeded to a passivation step which involved soaking them in a dichromate solution for a fixed period of time. The time period between the end of the coating run and the onset of the passivation step was varied from 0 (i.e., no delay) to 3.5 minutes. During the time period between plating and passivation, the barrel was held in air while continuing rotation. Following passivation, the components were dried and recovered.

The components were then evaluated by visual inspection. The components were assessed as either passing or failing. The Ni—W alloy layer on “passing” components was characterized as having a uniform appearance. On “failing components”, the Ni—W layer showed some discoloration and/or were not uniform in appearance.

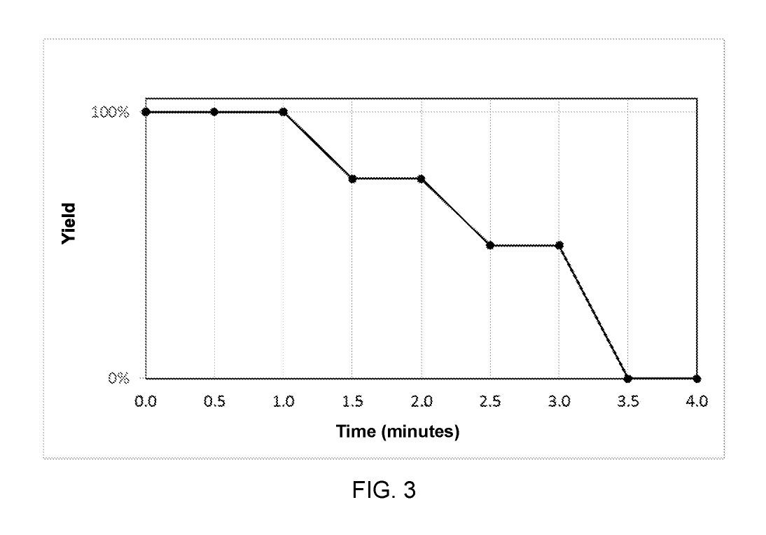

FIG. 3 is a graph showing the yield (i.e., % of the components deemed to “pass” the evaluation) versus the time between plating and passivation. The graph shows that the yield depends on the time.

What is claimed is:

1. A method comprising:
loading a barrel with a plurality of components;
rotating the barrel in an electroplating bath; and
electroplating a nickel tungsten alloy layer on surfaces of the components, wherein the electroplating rate is between 0.001 microns/minute and 10.0 microns/minute, wherein the nickel tungsten alloy layer forms at least a portion of a coating on surfaces of the components.

2. The method according to claim 1, wherein the electroplating rate is between 0.01 microns/minute and 5.0 microns/minute.

3. The method according to claim 1, wherein the barrel is rotated at a rotation linear velocity of between 1 cm/s and 20 cm/s.

4. The method according to claim 1, wherein the barrel is rotated at a rotation linear velocity of between 3 cm/s and 10 cm/s.

5. The method according to claim 1, wherein the ratio of bath volume to surface area of the components in the barrel is greater than or equal to 30.

6. The method according to claim 1, wherein the bath has a pH between 7.8 and 9.0.

7. The method according to claim 1, wherein the bath has a pH between 8.1 and 8.5.

8. (canceled)

9. The method according to claim 1, further comprising electroplating one or more layers on the nickel tungsten alloy layer, wherein the one or more layers forms a portion of the coating.

10. The method according to claim 1, further comprising electroplating a layer comprising nickel on the nickel tungsten alloy layer.

11. The method according to claim 10, comprising electroplating a layer comprising a second nickel tungsten alloy on the nickel tungsten alloy layer.

12. The method according to claim 11, wherein the second nickel tungsten alloy layer has a tungsten concentration that is lower than the nickel tungsten alloy layer.

13. The method according to claim 12, wherein the second nickel tungsten alloy layer has a tungsten concentration between 10 weight percent and 25 weight percent and the nickel tungsten ally layer has a tungsten concentration between 25 weight percent and 50 weight percent.

14. The method according to claim 9, comprising electroplating a layer comprising one or more precious metals on the nickel tungsten alloy layer.

15-17. (canceled)

18. The method according to claim 1, further comprising passivating coated components after electroplating the nickel tungsten layer and any electroplated layers on the nickel tungsten alloy layer.

19. The method according to any claim 18, wherein passivating comprises exposing coated components to a passivating solution comprising a chromate compound.

20. (canceled)

21. The method according to claim 18, wherein the coated components are passivated prior to drying the coated components.

22. The method according to claim 18, wherein the time period between the passivating step and the electroplating step is less than 1 minute.

23-24. (canceled)

25. An electrical connector comprising:
a conductive base; and
a nickel tungsten alloy layer formed on the conductive base,
wherein the electrical connector is free of a layer comprising tin or a precious metal.

26. An electrical connector comprising:
a conductive base; and
a nickel tungsten alloy layer formed on the conductive base,
wherein the electrical connector is configured to provide electrical grounding.

27. An electrical connector comprising:
a conductive base; and
a nickel tungsten alloy layer formed on the conductive base,
wherein the electrical connector is configured to provide a mechanical attachment.

28-44. (canceled)
